(19) United States
(12) Patent Application Publication
(10) Pub. No.: US 2009/0168186 A1
(43) Pub. Date: Jul. 2, 2009

(54) DEVICE AND METHOD FOR REDUCING ETENDUE IN A DIODE LASER

(76) Inventors: Forrest Williams, Sandy, UT (US); Robert Christensen, Rapid City, SD (US); Allen Tanner, Sandy, UT (US)

Correspondence Address: GRANT R CLAYTON;CLAYTON HOWARTH & CANNON, PC, P O BOX 1909, SANDY, UT, 84091-1909, US

(21) Appl. No.: 12/206,582

(22) Filed: Sep. 8, 2008

Related U.S. Application Data
(60) Provisional application No. 60/967,883, filed on Sep. 7, 2007.

(51) Int. Cl. G02B 27/10

(52) U.S. Cl. 359/621; 359/627

(57) ABSTRACT

An optical assembly for reducing the etendue of a diode laser light source having a plurality of laser light emitters. The optical assembly comprises a first optical device for collimating beams of light emitted from the emitters of the diode laser. A second optical device spatially shifts a portion of the collimated light beams emitted from the diode laser to thereby reduce gaps or dark space between the beams. A third optical device focuses all of the light beams onto a surface, such as a surface of a light modulation surface.

### REFERENCE TO RELATED APPLICATIONS

This application claims the benefit of U.S. Provisional Application No. 60/967,883, filed Sep. 7, 2007, which is hereby incorporated by reference herein in its entirety, including but not limited to those portions that specifically appear hereinafter, this incorporation by reference being made with the following exception: In the event that any portion of the above-referenced provisional application is inconsistent with this application, this application supercedes said above-referenced provisional application.

### STATEMENT REGARDING FEDERALLY SPONSORED RESEARCH OR DEVELOPMENT

Not Applicable.

### BACKGROUND

1. The Field of the Disclosure

The present disclosure relates generally to optical systems for diode lasers, and more particularly, but not necessarily entirely, to systems and methods for reducing the overall etendue in diode lasers having a plurality of emitters.

2. Description of Background Art

Until recently, the problem with most diode lasers was that they were too large, cost too much, performed too poorly and did not provide the needed output power to be utilized in many applications, such as to be utilized in consumer products. Newly developed technology addresses these problems by providing a more cost effective, energy efficient and lightweight alternative to previous diode laser platforms. The new diode based lasers are seen as an improvement over other previously available light sources.

Significantly, newly developed diode-based lasers are relatively compact, have low power consumption and they have the potential of low cost mass production. Further, recent improvements in diode-based laser technology has led to increased power output thereby making diode-based lasers more attractive for certain high-powered applications that include, inter alia, telecommunications, optical networks, healthcare, lighting, televisions, projection systems, and other consumer products.

However, certain drawbacks still exist in the use of diode lasers. One drawback is that while power output for diode lasers has been improved, a “single” diode laser, sometimes referred to herein as an “emitter,” is still unable to produce sufficient power for some applications. In order to compensate for the power deficiency, some laser manufacturers have bundled multiple emitters together on a single assembly to form an array of emitters in a “single” laser light source. Thus, a light beam from such a laser light source may in fact comprise multiple beams generated by an array of emitters. These arrays may be one-dimensional or two-dimensional.

FIG. 1 illustrates a perspective exploded view of a previously available diode laser light source 10. A gallium arsenide chip 12 comprises a two-dimensional array 14 of laser emitters 16. The array 14 comprises a first row of emitters 16, one emitter in the first row of emitters being denigrated 18, and a second row of emitters 16, one emitter in the second row of emitters being designated 20 (the reference numeral 18 will be used to refer to the first row of emitters and the reference numeral 20 will be used to refer to the second row of emitters). As can be observed from FIG. 1, the row 18 and the row 20 are spaced apart by a distance D₁. The emitters 16 in each of the rows 18 and 20 are spaced apart by a distance D₂.

The emitters 16 may emit light in the infrared portion of the electromagnetic spectrum. In order to convert this light into a frequency in the visible portion of the spectrum, a frequency doubler 22, such as a standard bulk periodically poled lithium niobate (PPLN) nonlinear crystal, may be utilized. Further, an output coupler 24, a device for extracting beams from laser cavities, is used to complete a laser cavity. It will be appreciated that the emitters 16, the frequency doubler 22 and the output coupler 24 represented in FIG. 1 are all diagrammatically represented and those skilled in the art will readily be able to select devices in accordance with the desired application. It will also be appreciated that the laser light source 10 may emit one of red, green and blue light.

Referring now to FIG. 2A, there is shown an unexploded view of the laser light source 10 depicted in FIG. 1 where like reference numerals illustrate the same components. Light beams 26 are emitted from the laser light source 10 in the same pattern as the array 14 of emitters 16 on the chip 12 as shown in FIG. 1. For this reason, the beams 26 are emitted in a first row 32 and a second row 34 from the laser light source 10 in a pattern 15 that corresponds to the pattern of the array 14. However, for purposes of convenience and clarity, only a single beam 26A from the first row 32 and a single beam 26B from the second row 34 are shown in FIG. 2. It will be understood that emitters 16 (visible in FIG. 1) on the chip 12 emit laser light in the pattern 15 from the output coupler 24. It will be noted that the beams 26A and 26B are diverging after exiting the output coupler 24.

Referring now to FIG. 2B, there is shown an unexploded top view of the laser light source 10 depicted in FIGS. 1 and 2A, where like reference numerals illustrate the same components. The row 32 of light beams is visible, but it is to be understood that light beams in row 34 reside directly beneath the light beams in the row 32. Due to their high divergence factor, adjacent beams 26 in the same rows emitted from the laser light source 10 intersect with each other along a plane indicated by the dashed lines marked with the reference numeral 47. The beams 26 may combine to form an image 70 with a Gaussian distribution on a surface 72 as is shown in FIG. 2C. It will be understood that the resulting image 70 of all of the beams 26 from the emitters 16 is unsuitable for use with some applications, including some types of light modulating devices, such as a differential interferometric light modulator that includes a one-dimensional array of micro-electro-mechanical (“MEMS”) structures for modulating light.

The previously available devices are thus characterized by several disadvantages that are addressed by the present disclosure. The present disclosure minimizes, and in some aspects eliminates, the above-mentioned failures, and other problems, by utilizing the methods and structural features described herein. The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a perspective exploded view of a diode laser pursuant to an embodiment of the present disclosure;

FIG. 2A is an unexploded perspective view of the diode laser illustrated in FIG. 1;

FIG. 2B is an unexploded top view of the diode laser illustrated in FIG. 1;

FIG. 2C is an image formed by the diode laser illustrated in FIG. 1 without the use of the present disclosure;

FIG. 3 is a perspective view of a diode laser and a optical assembly pursuant to an embodiment of the present disclosure;

FIG. 4A is a side view of a diode laser, optical lens assembly and resultant beam paths pursuant to an embodiment of the present disclosure;

FIG. 4B is a side view of a diode laser, optical lens assembly and resultant beam paths pursuant to an embodiment of the present disclosure;

FIG. 5A is a perspective view of an optical lens assembly for reducing etendue and resultant beam paths pursuant to an embodiment of the present disclosure;

FIG. 5B is a side view of the optical lens assembly and resultant beam paths shown in FIG. 5A;

FIG. 5C is a top view of the optical lens assembly and resultant beam paths shown in FIG. 5A;

FIG. 5D is a cross-sectional view of the optical lens assembly and resultant beam paths shown in FIG. 5A, taken along the section A-A shown in FIG. 5C;

FIG. 6 is a top view of a diode laser, optical lens assembly and resultant beam paths pursuant to an embodiment of the present disclosure;

FIG. 7 depicts a line image formed by a diode laser and optical lens assembly for reducing etendue pursuant to an embodiment of the present disclosure;

FIG. 8 depicts a system with multiple light sources and reduced etendue pursuant to an embodiment of the present disclosure; and

FIG. 9 depicts a system with multiple light sources and reduced etendue pursuant to an embodiment of the present disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

The publications and other reference materials referred to herein to describe the background of the disclosure, and to provide additional detail regarding its practice, are hereby incorporated by reference herein in their entireties, with the following exception: In the event that any portion of said reference materials is inconsistent with this application, this application supercedes said reference materials. The reference materials discussed herein are provided solely for their disclosure which was available prior to the filing date of the present application as well as the filing date of the application to which the present application claims the benefit of. Nothing herein is to be construed as a suggestion or admission that the inventors are not entitled to antedate such disclosure by virtue of prior disclosure, or to distinguish the present disclosure from the subject matter disclosed in the reference materials.

It must be noted that, as used in this specification and the appended claims, the singular forms “a,” “an,” and “the” include plural referents unless the context clearly dictates otherwise. In claiming the present invention, as well as describing the embodiments of the present disclosure, the following terminology will be used in accordance with the definitions set out below. As used herein, the terms “comprising,” “having,” “including,” “containing,” “characterized by,” and grammatical equivalents thereof are inclusive or open-ended terms that do not exclude additional, unrecited elements or method steps.

Applicants have derived an optical lens assembly for reducing the etendue of a diode laser. Etendue is a measure of the spatial purity of light as it propagates through an optical system. No optical system can improve upon the initial spatial purity of a light beam or bundle thereof. It can only preserve or degrade the beam quality from its initial state. The concept of reducing etendue as described in the present disclosure can be best understood by starting with an array of individual laser diode emitters disposed on a surface of a single chip, where small gaps exist between the individual emitters. The array of emitters may be treated as a system. This overall system has a corresponding etendue associated with it, which may be referred to as the native etendue or apparent etendue of the system. As the gaps between the individual emitters are reduced, the native or apparent etendue of the system is effectively reduced. Stated another way, the original system's area and solid angle are being reduced when the gaps between the individual emitters are reduced. However, the concept of reducing etendue as used herein in conjunction with the present disclosure refers to optically reducing and collapsing the gaps or dark space between the beams emitted by the array of emitters to thereby reduce the overall etendue of the system, i.e., the array of emitters.

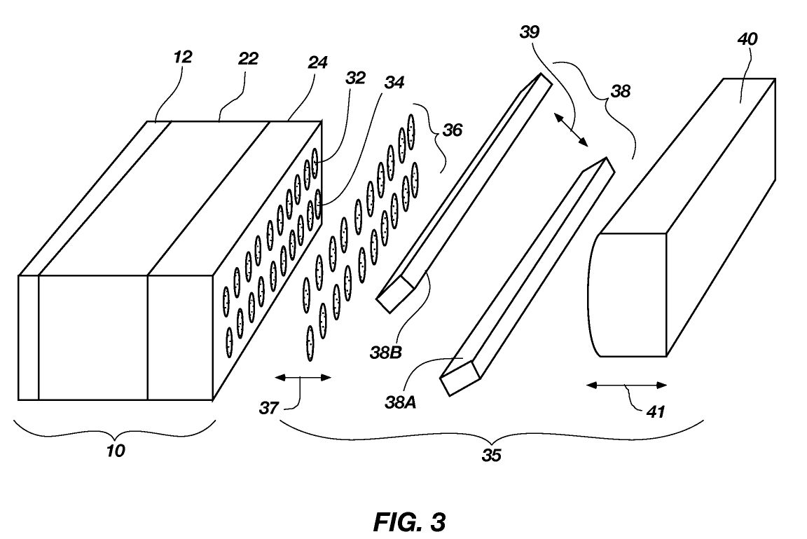

Referring now to FIG. 3, there is shown an embodiment of a system 35 pursuant to the present disclosure that is able to reduce the apparent etendue of the array of laser beams emitted from the laser light source 10 by reducing the gaps or dark space between the beams. A first optical device 36 is placed in front of the laser light source 10. The first optical device 36 may shape each of the beams emitted from the light source 10 by collimating or reducing the divergence of the beams. A second optical device 38 is disposed after the first optical device 36 and in the path of any beams that exit from the bottom row 34 of the light source 10. The second optical device 38 may comprise a first reflective surface 38A and a second reflective surface 38B. A third optical device 40 is disposed after the second optical device 38 and is operable to focus the beams emitted from the laser light source 10.

The first optical device 36 may be dynamically adjustable as indicated by the double arrow marked with the reference numeral 37. The second optical device 38 may be dynamically adjustable as indicated by the double arrow marked with the reference numeral 39. The third optical device 40, may be dynamically adjustable as indicated by the double arrow marked with the reference numeral 41. The dynamically adjustable feature of the devices 36, 38 and 40 may allow for proper adjustment of the devices 36, 38, and 40 to match the characteristics of laser source 10. The first optical device 36, the second optical device 38 and the third optical device 40 may form the system 35 for reducing etendue of the laser light source 10.

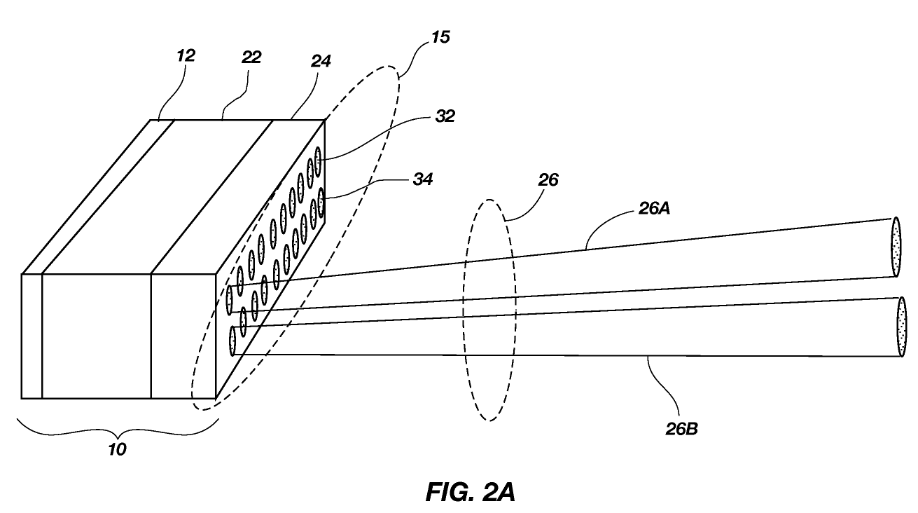

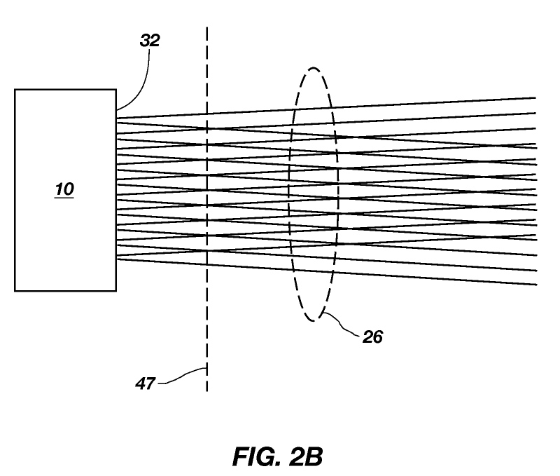

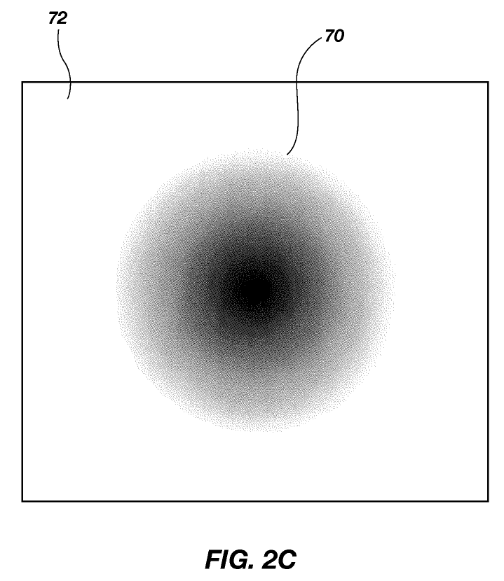

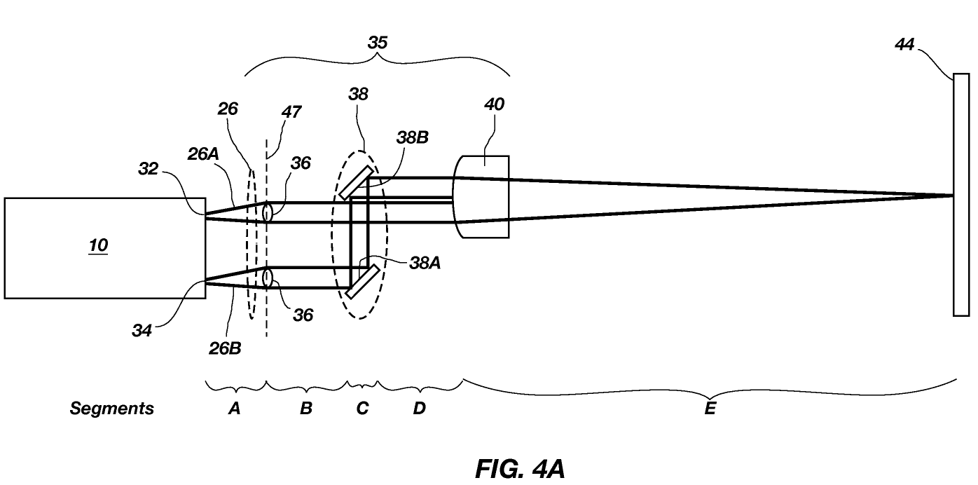

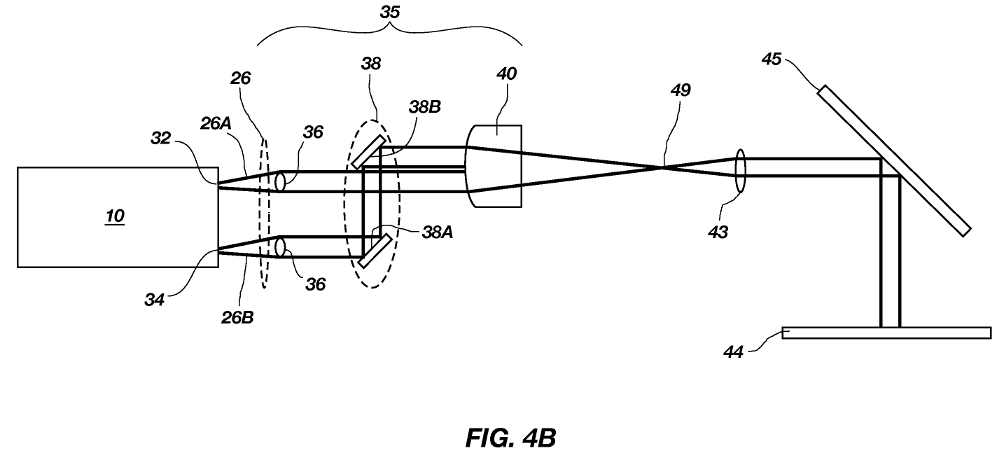

Referring now to FIG. 4A, there is shown a side view of the laser light source 10 and the system 35, which comprises the optical devices 36, 38 and 40. Beam 26A from the first row 32 and beam 26B from the second row 34 are emitted from the laser light source 10 and propagate along an optical path comprising Segments A, B, C, D and E. It will be appreciated that the beam 26A represents all of the beams in the top row 32 and that the beam 26B represents all of the beams in the bottom row 34. It will be noted that the placement of the first optical device 36 is at approximately the plane 47 (see FIG. 2B) where the beams 26 in the same row would otherwise intersect each other. The first optical device 36 may be placed before, at, or after these intersections.

Along Segment A, both beams 26A and 26B are diverging. Optical device 36 collimates the beams 26A and 26B so that the beams 26A and 26B propagate in parallel directions along Segment B. At the end of Segment B, the beam 26B encounters the reflecting surface 38A of the second optical device 38 such that the beam 26B is directed approximately perpendicular to its path of travel along Segment B. The reflecting surface 38A may be disposed at approximately a 45 degree angle with respect to the direction of propagation of the beam 26B along Segment B. The second reflective surface 38B reflects the beam 26B along Segment D in a path parallel to, but offset from, the path that the beam 26B traveled in Segment B, and into the third optical device 40. The reflecting surface 38B may be disposed at approximately a 45 degree angle. Thus, along Segment C, the beam 26B is spatially shifted closer to the path of beam 26A to thereby reduce gaps or dark space between it and the beam 26A. The collimated beam 26A travels unaltered through Segments B, C and D to the third optical device 40. The third optical device 40 is operable to focus the beams 26A and 26B onto a surface 44 as the beams 26A and 26B travel along Segment E.

Referring now to FIG. 4B, there is shown a side view of the laser light source 10 and the system 35, which comprises the optical devices 36, 38 and 40, where like reference numerals indicate the same components. In FIG. 4B, a fourth optical device 43, disposed after the focal point 49 of the third optical device 40, is used to collimate the light from the third optical device 40. The collimated light may be reflected from a reflective device 45 onto the surface 44.

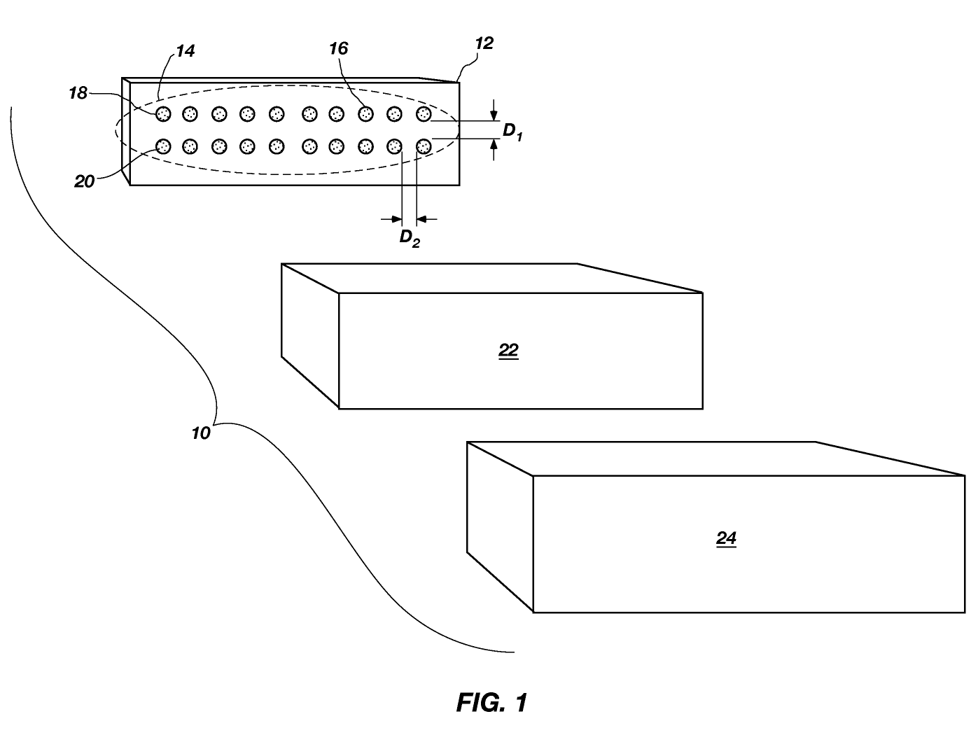

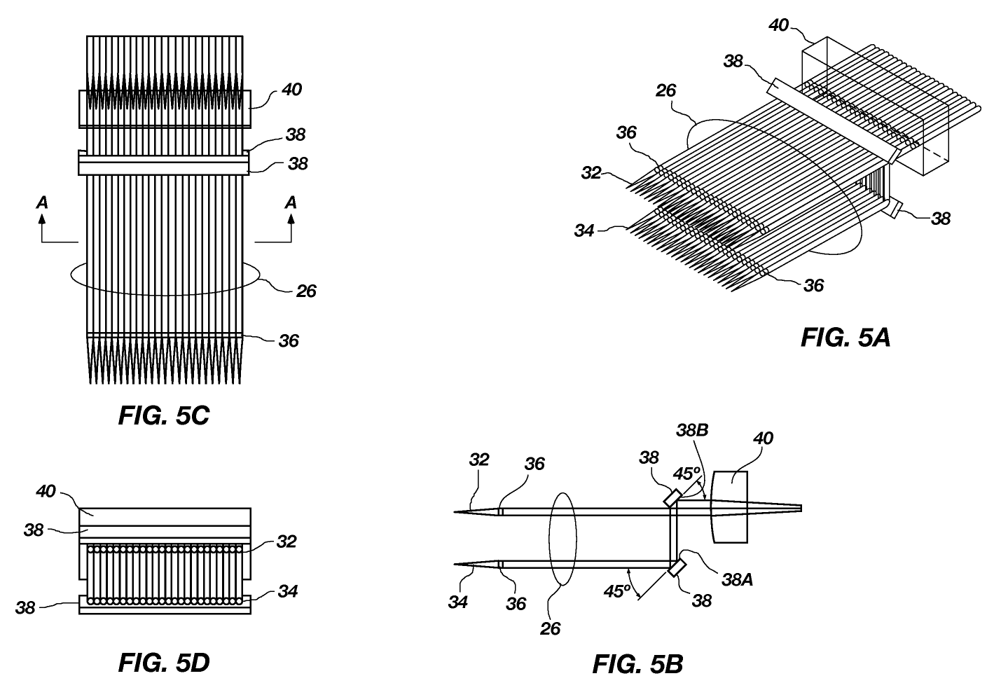

FIGS. 5A-5D depict various views of an embodiment of the present disclosure where like reference numerals represent like components. Instead of the light source 10 emitting twenty beams 26 as contemplated relation to FIGS. 1-4B, forty-eight beams 26 are emitted in two rows 32 and 34, with twenty-four beams each, from a laser light source (not explicitly shown). The laser light source may comprise an array of forty-eight emitters (not explicitly shown in FIGS. 5A-5D) arranged in two rows corresponding in number and orientation to that of the forty-eight beams 26 in the rows 32 and 34.

The optical device 36 is positioned in the path of all of the beams 26 and is operable to collimate each of the beams 26. Next, the optical device 38 spatially shifts the collimated beams 26 in the row 34 to thereby reduce the gap between the rows 32 and 34. In particular, the optical device 38 comprises two reflective surfaces 38A and 38B for shifting the beams 26 in the row 34 close to the beams 26 in row 35. It will be noted that the reflective surfaces 38A and 38B may be coated with a wavelength-dependent reflective coating. After the beams 26 interact with optical device 38, optical device 40 focuses the beams 26 onto a surface (not shown), such as a surface of a light modulation device. It will be noted that the embodiments illustrated in FIGS. 5A-5D are configured for a laser light source emitting beams 26 having a wavelength of approximately 532 nanometers. It will be appreciated that an embodiment of the present disclosure may be optimized to function with other wavelengths of light as well.

Still referring to FIGS. 5A-5D, in embodiments of the present disclosure, the optical device 36 may comprise a plurality of spherical lenses. For example, a single lens may be placed in the path of each of the beams 26 such that each of the beams 26 is separately and individually collimated. In an embodiment of the present disclosure, a lens suitable for use with optical device 36 is about 0.250 millimeters thick, has a radius of curvature of about 1.593 millimeters, and an effective focal length of about 2.69 millimeters. In an embodiment of the present disclosure, the reflecting surfaces 38A and 38B of the optical device 38 may comprise wavelength-dependent coatings to optimize the reflection of light. In an embodiment of the present disclosure, the optical device 40 may comprise a lens about 2 millimeters thick, and having a radius of curvature of about 20 millimeters and an effective focal length of about 33.9 millimeters. The optical device 40 may shape the beams 26.

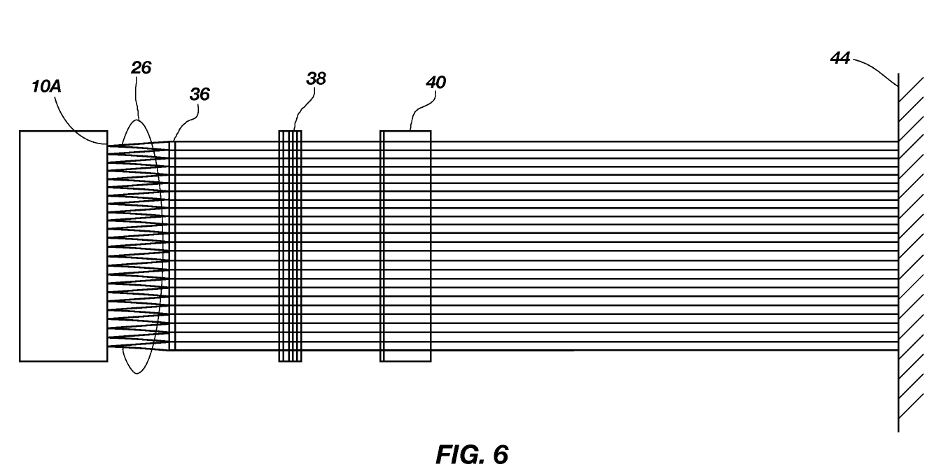

FIG. 6 illustrates a top view of a laser light source 10A, where like reference numerals depict like components. The beams 26 are emitted from the laser light source 10A. The first optical device 36 collimates the beams 26. The second optical device 38 spatially shifts a first portion of the beams closer to a second portion of the beams to thereby reduce gaps and dark space between the beams 26. The third optical device 40 focuses the beams 26 onto a surface 44, such as the operative surface of a light modulation device.

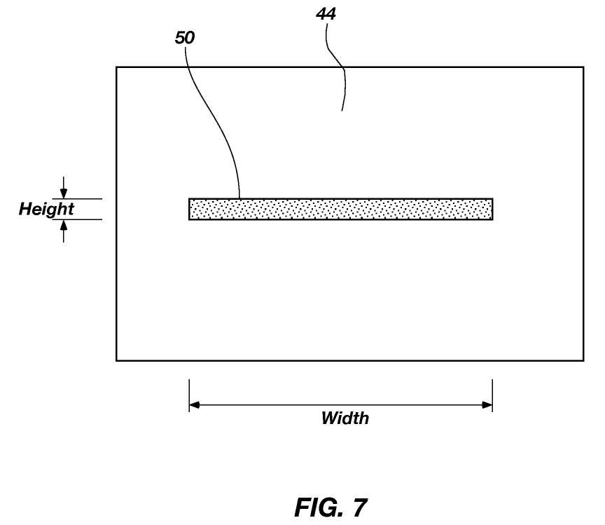

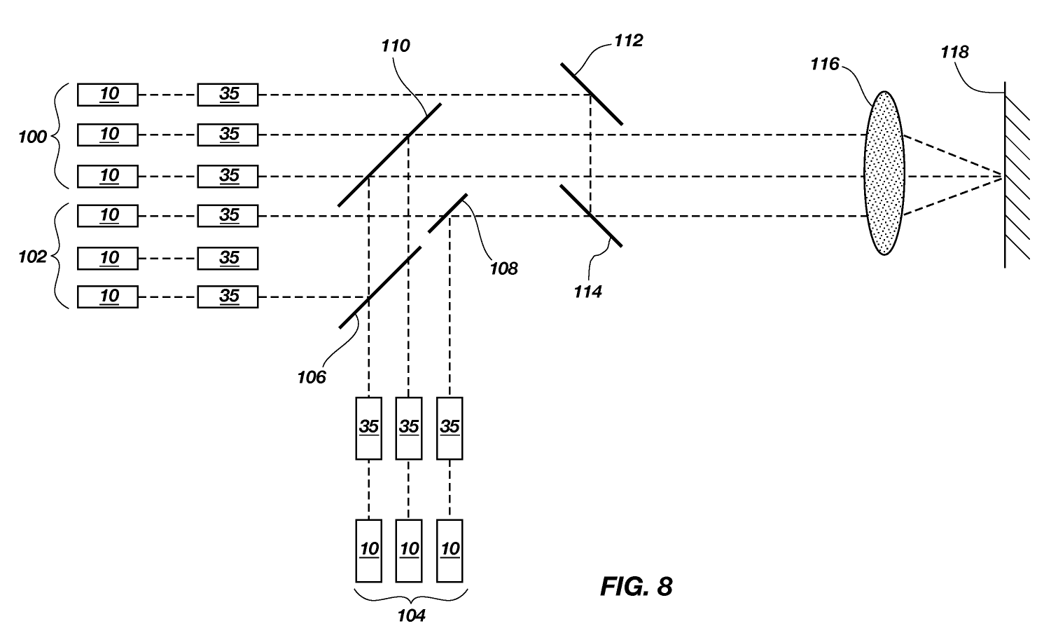

FIG. 7 illustrates a view of an image 50 on the surface 44 formed by the optical devices 36, 38, and 40 (FIG. 6). The image 50 has a very small height relative to the width of the image 50, which is sometimes referred to as a line image or a one-dimensional image, in contrast to the circular image 70 shown in FIG. 2C. The image 50 is more suitable for use with some types of light modulation devices, including a differential interferometric light modulator or grating light valve (“GLV®”) device, than the image 70 depicted in FIG. 2C. A GLV device switches and modulates light intensities via diffraction. The GLV technology uses a series of microscopic ribbons on the surface of a silicon chip. The ribbons are arranged in a single column and thus, the image 50 formed by the present disclosure, a line image, is particularly suited for use with a GLV based light modulator.

In particular, a GLV device is a diffractive MEMS system that acts as a dynamic, tunable grating, that can switch, attenuate and modulate laser light with high precision. Compared to other MEMS, the GLV device offers significant advantages in terms of speed, accuracy, reliability and ease of manufacturing. As example of a suitable differential interferometric light modulator is disclosed in U.S. Pat. No. 7,054,051 which is now hereby incorporated by reference in its entirety into the present application. U.S. Pat. Nos. 7,277,216 and 7,286,277 and U.S. Patent Publication No. US2006/0238851 are also now hereby incorporated by reference in their entireties into the present application.

FIG. 8 depicts an optical system for combining beams from three groups 100, 102, and 104 of laser light sources 10. Each of the plurality of laser light sources 10 may comprise an array of emitters as described above. In an embodiment of the present disclosure, each of the groups 100, 102, and 104 of laser light sources 10 may emit a unique color of light. In an embodiment of the present disclosure, the group 100 may emit blue light, the group 102 may emit green light, and the group 104 may emit red light. Further, while only three laser light sources 10 are depicted for each of the groups 100, 102, and 104, it will be appreciated that any number of laser light sources 10 may be utilized within each group 100, 102, and 104. Optics 106, 108, 110, 112, and 114 may be coated to either reflect or transmit specific wavelengths as shown in FIG. 8 to thereby direct light from the laser light sources 10 onto a lens 116. The lens 116 may focus the light from the laser light sources 10 onto a surface 118, such as the surface of a light modulation device. The light from each of the laser light sources 10 may first pass through one of systems 35 for reducing its overall etendue in a similar fashion to that described above. It will be appreciated that the combination of multiple laser light sources 10 for each color increases the power of the system. In a typical arrangement, each of the groups 100, 102, and 104 is pulsed separately.

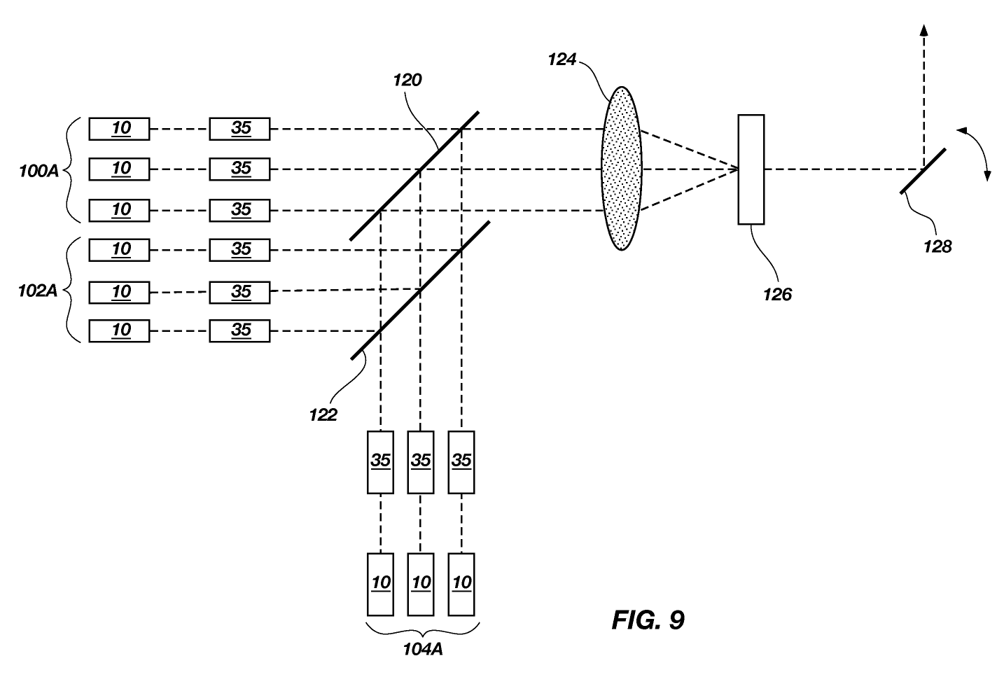

FIG. 9 depicts an optical system for combining beams from three groups 100A, 102A, and 104A of laser light sources 10. Each of the plurality of laser light sources 10 may comprise an array of emitters as described above. In an embodiment of the present disclosure, each of the groups 100A, 102A, and 104A of laser light sources 10 may emit a unique color of light. In an embodiment of the present disclosure, the group 100A may emit blue light, the group 102A may emit green light, and the group 104A may emit red light. Further, while only three laser light sources 10 are depicted for each of the groups 100A, 102A, and 104A, it will be appreciated that any number of laser light sources 10 may be utilized within each group 100A, 102A, or 104. Optics 120 and 122 may be coated to either reflect or transmit specific wavelengths as shown in FIG. 9 to thereby direct light from the laser light sources 10 onto a lens 124. The lens 124 may focus the light from the laser light sources 10 onto a light modulation device 126. Modulated light may then be scanned by a scanning device 128 onto a viewing surface to thereby form a desired image.

The light from each of the laser light sources 10 in FIG. 9 may first pass through one of systems 35 for reducing the overall etendue of the light in a similar fashion to that described above. It will be appreciated that the combination of multiple laser light sources 10 for each color increases the power of the system. In a typical arrangement, each of the groups 100A, 102A, and 104A is pulsed separately.

It will be noted that the optical devices described herein may be configured to be wavelength dependent. As used herein, the term “wavelength dependent” means that an optic is designed and constructed to work optimally with a particular wavelength of light, and may include a coating material. Further, the present disclosure is suitable for many applications, including, without limitation, medical purposes, welding applications, the application of powdered deposition applications and projection systems. Further, the lenses as used herein, may be cylindrical, spherical, or anamorphic. Further, optical coatings may be used as needed to accomplish the purposes described herein. In this regard, a light source 10 may emit visible, invisible, or infrared light. Further, a light source 10 may emit coherent light.

Those having ordinary skill in the relevant art will appreciate the advantages provide by the features of the present disclosure. For example, it is a feature of the present disclosure to provide an optical lens assembly for reducing the etendue of a diode laser having a plurality of emitters. Another feature of the present disclosure is to provide an optical lens assembly that permits a diode laser light source to be used with a light modulation device.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. An apparatus for reducing etendue of a laser light source having a plurality of emitters grouped into a first group of emitters and a second group of emitters, said apparatus comprising:
a first optical device for collimating light emitted from the plurality of emitters;
a second optical device for reducing a spatial separation between light from the first group of emitters and light from the second group of emitters; and
a third optical device for focusing the light from the first group of emitters and the second group of emitters.

2. The apparatus of claim 1, wherein the first optical device comprises a plurality of lenses.

3. The apparatus of claim 1, wherein the first optical device comprises a wavelength-dependent coating.

4. The apparatus of claim 1, wherein the first optical device is dynamically adjustable.

5. The apparatus of claim 1, wherein the second optical device comprises at least one reflecting surface.

6. The apparatus of claim 1, wherein the second optical device comprises two reflecting surfaces.

7. The apparatus of claim 5, wherein the at least one reflecting surface comprises a wavelength-dependent coating.

8. The apparatus of claim 6, wherein the two reflecting surfaces each comprises a wavelength-dependent coating.

9. The apparatus of claim 1, wherein the third optical device comprises a lens.

10. The apparatus of claim 1, wherein the third optical device focuses light from the first group of emitters and the second group of emitters into a line image.

11. The apparatus of claim 1, further comprising a light modulation device, and wherein the third optical device focuses the light from the emitters onto the light modulation device.

12. An apparatus for reducing etendue of a light source having a plurality of spatially separated emitters, said apparatus comprising:
a first optical device for shaping light emitted from the emitters;
a second optical device for reducing a spatial separation between the shaped light; and
a third optical device for focusing the light from the emitters onto a surface.

13. The apparatus of claim 12, wherein the first optical device comprises at least one lens.

14. The apparatus of claim 12, wherein the first optical device comprises a wavelength-dependent coating.

15. The apparatus of claim 12, wherein the first optical device is dynamically adjustable.

16. The apparatus of claim 12, wherein the second optical device comprises at least one reflecting surface.

17. The apparatus of claim 12, wherein the second optical device comprises two reflecting surfaces.

18. The apparatus of claim 16, wherein the at least one reflecting surface comprises a wavelength-dependent coating.

19. The apparatus of claim 17, wherein the two reflecting surfaces each comprises a wavelength-dependent coating.

20. The apparatus of claim 12, wherein the third optical device comprises a lens.

21. The apparatus of claim 12, wherein the third optical device focuses the light from the emitters into a line image.

22. The apparatus of claim 21, further comprising a light modulation device, and wherein the third optical device focuses the line image onto a surface of the light modulation device.

23. A method for reducing etendue of a light source having a plurality of emitters grouped into a first group of emitters and second group of emitters, said method comprising the steps of:
collimating light emitted from each of the plurality of emitters;
spatially shifting light to thereby reduce a spatial separation between light emitted from the first group of emitters and light emitted from the second group of emitters; and
focusing the light from the first group of emitters and light emitted from the second group of emitters onto a surface.

24. The method of claim 23, wherein the step of collimating the light emitted from each of the plurality of emitters comprises the step of using spherical lenses to collimate the light.

25. The method of claim 24, wherein each of the spherical lenses comprises a wavelength-dependent coating.

26. The method of claim 23, wherein the step of spatially shifting light comprises the step of using at least one reflecting surface.

27. The method of claim 23, wherein the step of spatially shifting light comprises the step of using at least two reflecting surfaces.

28. The method of claim 23, wherein the step of focusing the light comprises the step of using a lens.

29. The method of claim 28, wherein the lens is a type selected from the groups consisting of cylindrical lenses, spherical lenses and anamorphic lenses.

30. The method of claim 28, wherein the lens includes a coating optimized for use with a single wavelength of light.

31. The method of claim 23, wherein the method is used for medical purposes.

32. The method of claim 23, wherein the method is used for welding purposes.

33. The method of claim 23, wherein the method is used in a projection system.

34. A light emitting apparatus having a reduced etendue, the apparatus comprising:
a laser light source having a plurality of emitters grouped into a first group of emitters and a second group of emitters;
a first optical device for collimating light emitted from the plurality of emitters;
a second optical device for reducing spatial separation between light emitted from the first group of emitters and light emitted from the second group of emitters; and
a third optical device for focusing the light from the first group of emitters and the light from the second group of emitters.

35. The apparatus of claim 34, wherein said plurality of emitters comprise diode lasers.

36. The apparatus of claim 34, wherein said first group of emitters and said second group of emitters form an array.

37. The apparatus of claim 36, wherein said array is a two-dimensional array.

38. The apparatus of claim 34, wherein the emitters are semiconductor devices.

39. The apparatus of claim 34, further comprising a light modulation device, and wherein said third optical device focuses a line image onto the light modulation device.

40. The apparatus of claim 34, wherein said plurality of emitters are disposed on a chip.

41. An optical system having a plurality of light sources, each of the plurality of light sources comprising a plurality of emitters, said optical system comprising:
a plurality of optical systems, each of the plurality of optical systems being associated with one of the plurality of light sources;
wherein each optical system is operable to reduce an etendue of its associated one of the plurality of light sources.

42. The optical system of claim 41, wherein each optical system comprises a first optical device for reducing gaps between beams of light emitted from the emitters of its associated one of the plurality of light sources.

43. The optical system of claim 42, wherein each optical system comprises lenses for collimating light from each of the emitters of its associated one of the plurality of light sources.

44. An apparatus for reducing etendue of a light source having a plurality of emitters, said apparatus comprising:
a first optical device for shaping light from the emitters;
a second optical device for spatially shifting light from the emitters; and
a third optical device for further shaping the light from the emitters.

45. The apparatus of claim 44, wherein the light source is a diode laser.

46. The apparatus of claim 44, wherein the light source emits visible light.

47. The apparatus of claim 44, wherein the light source emits infrared light.

48. The apparatus of claim 44, wherein the light source is coherent.

49. The apparatus of claim 44, wherein the first optical device comprises one or more lenses.

50. The apparatus of claim 44, wherein the first optical device is wavelength dependent.

51. The apparatus of claim 44, wherein the first optical device is dynamically adjustable.

52. The apparatus of claim 44, wherein the light emitted from the emitters is diverging such that a portion of the light emitted from the emitters forms an intersection, and the first optical device is placed at approximately the intersection.

53. The apparatus of claim 44, wherein the light emitted from the emitters is diverging such that a portion of the light emitted from the emitters forms an intersection, and the first optical device is placed before the intersection.

54. The apparatus of claim 44, wherein the light emitted from the emitters is diverging such that a portion of the light emitted from the emitters forms an intersection, and the first optical device is placed after the intersection.

55. The apparatus of claim 44, wherein the first optical device collimates the light.

56. The apparatus of claim 44, wherein the second optical device comprises at least one reflecting surface.

57. The apparatus of claim 44, wherein the second optical device comprises a plurality of reflecting surfaces.

58. The apparatus of claim 56, wherein the reflecting surface comprises a wavelength-dependent coating.

59. The apparatus of claim 44, wherein the third optical device comprises a lens.

60. The apparatus of claim 44, wherein the third optical device collimates the light.

61. The apparatus of claim 44, wherein the third optical device focuses the light.

62. An apparatus for reducing etendue of a system, the system having a plurality of light emitters separated by gaps, said apparatus comprising:
an optical system for reducing gaps between beams of light emitted from the emitters.

63. The apparatus of claim 62, wherein the optical system reduces a solid angle of the emitters.

64. The apparatus of claim 62, wherein the optical system comprises a first optical device for collimating light.

65. The apparatus of claim 64, wherein the optical system comprises a second optical device, the second optical device having at least one reflective surface.

66. The apparatus of claim 65, wherein the optical system comprises a third optical device for focusing light.
